(19) United States
(12) Patent Application Publication
(10) Pub. No.: US 2025/0131684 A1
(43) Pub. Date: Apr. 24, 2025

(54) PERSONALIZED IMAGE SEGMENTATION DEVICE AND METHOD THEREOF

(71) Applicant: ELECTRONICS AND TELECOMMUNICATIONS RESEARCH INSTITUTE, Daejeon (KR)

(72) Inventors: Chi Yoon JEONG, Daejeon (KR); Moo Seop KIM, Daejeon (KR)

(21) Appl. No.: 18/790,159

(22) Filed: Jul. 31, 2024

(30) Foreign Application Priority Data
Oct. 19, 2023 (KR) 10-2023-0140559

(51) Int. Cl. G06V 10/26; G06F 40/30

(52) U.S. Cl. CPC G06V 10/26; G06F 40/30

(57) ABSTRACT

Disclosed is a personalized image segmentation device, which includes a user input collector that outputs input information in a second format based on a user input in a first format received from a first external device, a sensing information analyzer that outputs context information based on sensing information received from a second external device, a user semantic information generator that analyzes personalized semantic information based on the input information and the context information and outputs personalized user input information based on the personalized semantic information, a multimodal foundation model that encodes image data and text information respectively to generate feature information corresponding to the image data, and an image-input decoder that detects an object corresponding to the user input on the image data based on the feature information and the personalized user input information.

### CROSS-REFERENCE TO RELATED APPLICATION(S)

This application claims priority under 35 U.S.C. § 119 to Korean Patent Application No. 10-2023-0140559 filed on Oct. 19, 2023, in the Korean Intellectual Property Office, the disclosures of which are incorporated by reference herein in their entireties.

### BACKGROUND

### 1. Field of the Invention

Embodiments of the present disclosure described herein relate to an image segmentation, and more particularly, relate to a personalized image segmentation device and a method thereof.

### 2. Description of Related Art

Image segmentation refers to the process of dividing an image into multiple sets of pixels to simplify or transform digital image representation to make it meaningful and easy to interpret. The image segmentation is used to find the boundaries of objects in an image. Recently, methods to improve the performance of the image segmentation using deep learning are being studied. Existing image segmentation methods are based on supervised learning, and are limited in classifying undefined object information at the stage of training deep learning models.

When a user inputs a text based on a multimodal foundation model learned by mapping image data and text information to the same latent space, RIS (Referring Image Segmentation) technology that may detect object information corresponding to the text is being researched. The RIS technology has the advantage of being able to detect object information that is not learned in advance by utilizing image feature information related to the user input information in the image segmentation process. However, in the case of RIS, object detection performance depends on the specific level of information input by a user. Therefore, there is a limitation in that the user should repeatedly input the same information to detect an object in images.

### SUMMARY

Embodiments of the present disclosure provide a personalized image segmentation device capable of increasing detection performance of image object information with only relatively simple input, and a method thereof.

According to an embodiment of the present disclosure, a personalized image segmentation device includes a user input collector that outputs input information in a second format based on a user input in a first format received from a first external device, a sensing information analyzer that outputs context information based on sensing information received from a second external device, a user semantic information generator that analyzes personalized semantic information based on the input information and the context information and outputs personalized user input information based on the personalized semantic information, a multimodal foundation model that encodes image data and text information respectively to generate feature information corresponding to the image data, and an image-input decoder that detects an object corresponding to the user input on the image data based on the feature information and the personalized user input information.

According to an embodiment of the present disclosure, a personalized image segmentation method includes determining whether a user input in a first format is received, generating input information in a second format based on the user input, collecting image data in response to the user input, generating context information based on analysis of collected sensing information, in response to the user input, generating personalized user input information based on personalized semantic information, the input information, and the context information, generating feature information corresponding to the image data, and detecting an object corresponding to the user input on the image data based on the feature information and the personalized user input information.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a personalized image segmentation device, according to an embodiment of the present disclosure.

FIG. 2 is a diagram for describing an example of personalized user semantic information generated by a user semantic information generator of FIG. 1.

FIG. 3 is a block diagram for describing a user semantic information generator of FIG. 1.

FIG. 4 is a flowchart illustrating a personalized image segmentation method, according to an embodiment of the present disclosure.

FIG. 5 is a flowchart for describing an update of a personalized semantic model of FIG. 3.

### DETAILED DESCRIPTION

Hereinafter, embodiments of the present disclosure will be described in detail and clearly to such an extent that an ordinary one in the art easily implements the present disclosure.

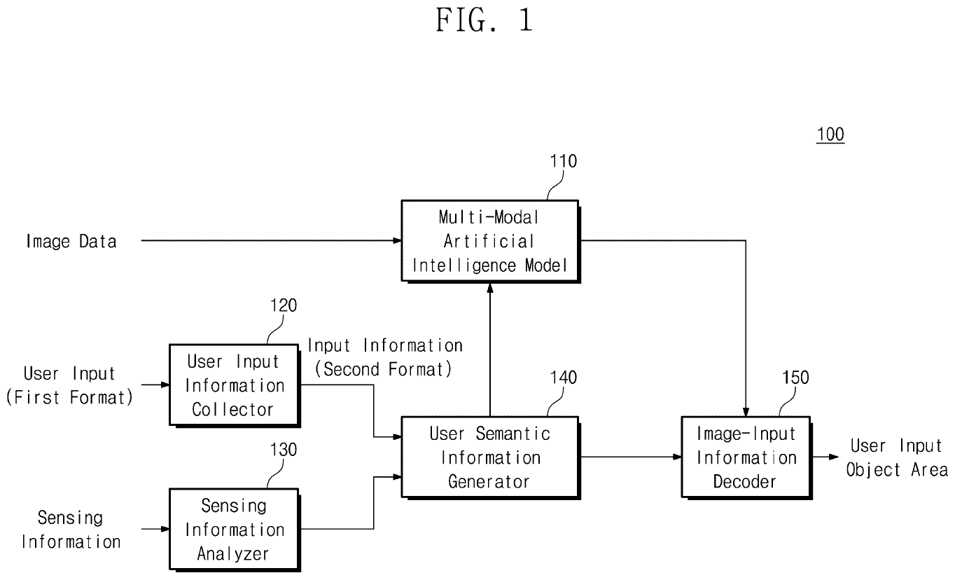

FIG. 1 is a block diagram illustrating a personalized image segmentation device, according to an embodiment of the present disclosure.

Referring to FIG. 1, a personalized image segmentation device 100 may include a multimodal foundation model 110, a user input information collector 120, a sensing information analyzer 130, a user semantic information generator 140, and an image-input information decoder 150.

The multimodal foundation model 110 is an artificial intelligence model that integrates data of different modalities such as image data or text data. The multimodal foundation model 110 may be learned in advance by mapping various modality data to a latent space, which is a space in which important features of original data are compressed and expressed. In detail, in pre-training of the multimodal foundation model 110, various modality data may be mapped to the same latent space. The multimodal foundation model 110 may include artificial intelligence models that integrate data of different modalities such as text and image, such as CLIP (Contrastive Language-Image Pre-training) and DALL⋅E GLIDE (Guided Language Diffusion for Generation and Editing). When image data is input to the multimodal foundation model 110, the multimodal foundation model 110 generates feature information associated with the image data. For example, the multimodal foundation model 110 may extract features from a single modality by encoding each of the collected image data and text data. In an embodiment, the multimodal foundation model 110 may map information associated with image data and text data into a feature space. The information associated with the text data may include at least one word. As an example, information associated with the text data may correspond to information associated with a phrase or sentence. In this case, the multimodal foundation model 110 may map information associated with the phrase or sentence into a feature space. The information associated with the phrase or sentence may include word information corresponding to each word composing text data or sentence information composed of a plurality of words.

The user input information collector 120 may output input information in a second format based on a user input in a first format received from at least one external device (e.g., a user interface device). In this case, the user input information collector 120 may generate input information in the second format by converting the user input in the first format to input information in the second format.

As an example, the user input information collector 120 may include a format converter. For example, the user input information collector 120 may include a speech-to-text converter that converts a speech format to a text format. In this case, the first format may include a speech format, and the second format may include a text format. The speech-to-text converter may perform speech-to-text (STT) conversion operations. The speech-to-text converter may include a voice recognition model to perform a STT conversion operation. In detail, when the user input information collector 120 receives speech input through a user interface device, the user input information collector 120 may generate input information in the text format corresponding to the user input in speech format through the speech-to-text converter. The user interface device may include a voice receiving device such as a microphone for inputting the user's voice.

The user input information collector 120 may include a handwriting-to-text converter that converts handwriting input into a text format. In this case, the first format may include an image format, and the second format may include a text format. The user interface device may include a touch screen for inputting a user's handwriting. The handwriting-to-text converter may perform text recognition operations. The handwriting-to-text converter may include a handwriting recognition model. In detail, when the user input information collector 120 receives a handwritten image input through the user interface device, the user input information collector 120 may generate input information in text format corresponding to the user input in image format through a handwriting-to-text converter. The user interface device may include an input device such as a touch screen for inputting a user's handwriting. Meanwhile, the first format may include a vector format including a vector trace with respect to the user's handwriting input. The handwriting-to-text converter may generate input information in text format corresponding to user input in vector format.

Meanwhile, the first format may be the same format as the second format. When each of the first format and the second format is a text format, the user input information collector 120 may output the user input without separately converting the user input. For example, when a user directly inputs text information through the user interface device, the user input may be output as input information as is without separate format conversion.

The sensing information analyzer 130 may output context information based on sensing information received from at least one external device (e.g., a sensor device). The sensor device may include inertial measurement units (IMUs), Global Navigation Satellite System (GNSS) receivers, etc.

The inertial measurement units may include an acceleration sensor, gyroscope, magnetometer, etc. The inertial measurement units may transmit inertial information collected through various sensors to the sensing information analyzer 130.

A GNSS receiver may receive GNSS signals from a plurality of GNSS signal generators, such as artificial satellites, and may analyze the GNSS signals to generate GNSS location information. The GNSS location information may include information about the current location of the GNSS receiver.

The GNSS receiver may generate location information using at least one satellite navigation system such as GPS (Global Positioning System), GLONASS, Beidou, Galileo, IRNSS, and QZSS.

In addition to inertial measurement devices and GNSS receivers, the sensor device may include various sensors such as barometric pressure sensors, temperature sensors, illuminance sensors, proximity sensors, and touch sensors. When generating context information, the sensing information analyzer 130 may use various sensing information received from a sensor device. The sensing information may include at least one of various information such as inertial information, location information, atmospheric pressure information, illuminance information, proximity information, and touch information.

The sensing information analyzer 130 may analyze the sensing information received from an external device. The sensing information analyzer 130 may use a machine learning algorithm or a deep learning model to analyze the received sensing information. The sensing information analyzer 130 may generate context information generated by analyzing the sensing information. The context information may indicate the user's current behavior, location, status, etc.

The user semantic information generator 140 may generate personalized user input information based on personalized semantic information, input information, and context information.

The input information is user input converted into a second format through the user input information collector 120. The context information is information about the user's current behavior, location, status, etc. generated through the sensing information analyzer 130.

The personalized semantic information is information about the user's unique features. For example, the personalized semantic information may include information about objects owned by the user, information about spaces that the user frequently visits, information about the user's tastes, etc.

The personalized user input information is a more specific user input obtained by analyzing personalized semantic information based on the input information. When materializing the input information into the personalized user input information, the user semantic information generator 140 may use the context information received from the sensing information analyzer 130 as described above. Through this, the personalized user input information that reflects the current user's context may be generated.

The image-input information decoder 150 may detect the object corresponding to the user input on the image data based on the feature information about the image data generated by the multimodal foundation model 110 and the personalized user input information generated by the user semantic information generator 140. The image-input information decoder 150 may utilize image data in the feature space, word information of text including a phrase or sentence, and sentence information to detect the object corresponding to the user input. Through this, the image-input information decoder 150 may detect an object area intended by the user on the image data.

The RIS (Referring Image Segmentation) technology uses the multimodal foundation model 110 learned by mapping image data and text data to the same latent space. The RIS technology encodes each of the text data and image data entered by the user, and then detects the object area entered by the user. In this case, for accurate object detection, it is required to input relatively specific and complex label information in text form. In addition, objects frequently searched by the user or objects dependent on the user are also required to repeatedly input the same user input.

The personalized image segmentation device 100 according to an embodiment of the present disclosure may generate specific information based on the user's context, and the user's personalized semantic information with a relatively simple user input. When applying the RIS to the personalized user input information specified from the user input, the personalized image segmentation device 100 may detect objects that match the user's intent even if a relatively simple user input is provided, and may increase object detection performance.

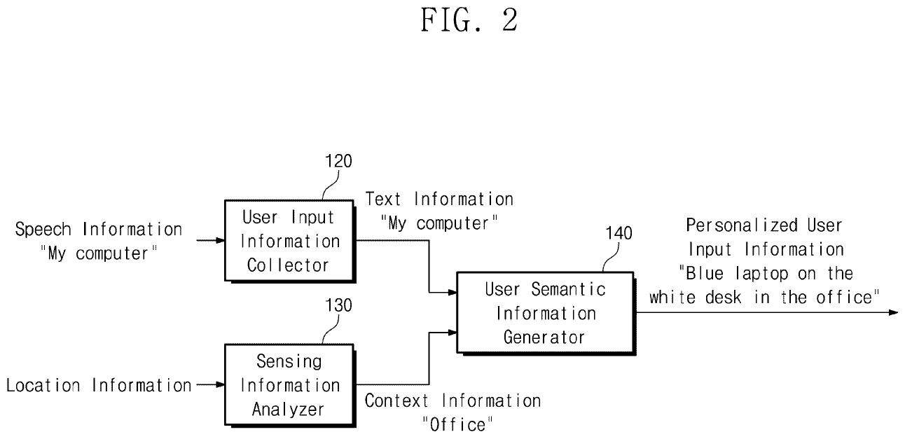

FIG. 2 is a diagram for describing an example of personalized user semantic information generated by a user semantic information generator of FIG. 1.

Referring to FIG. 2, the user semantic information generator may generate personalized user input information based on personalized semantic information, the input information, and the context information.

When a user speaks “My computer” to the user interface device, the user interface device may generate speech information “My computer.” The speech information “My computer” in a first format (e.g., a speech format) is transferred to the user input information collector 120. The user input information collector 120 may convert the speech information “My computer” into text information “computer” in a second format.

Meanwhile, when the user writes “My computer” through the user interface device, the user interface device may generate handwriting information “My computer”. The handwriting information “My computer” in a first format (e.g., an image format) may be transferred to the user input information collector 120. The user input information collector 120 may convert handwriting information “My computer” in an image format into the text information “My computer” in a second format. The user input information collector 120 may output the text information “My computer” to the user semantic information generator 140.

The sensing information analyzer 130 may receive location information from a sensor device in response to the user input. The sensing information analyzer 130 may identify the user's current spatial information based on the received location information. For example, the sensing information analyzer 130 may identify that the user's current location corresponds to “Office” based on the received location information. The sensing information analyzer 130 may generate context information including the user's current location. For example, the sensing information analyzer 130 may generate the context information “Office” corresponding to the user's current location.

The user semantic information generator 140 may analyze personalized semantic information based on the text information “My computer” converted to the second format and the spatial context information “Office” generated through the sensing information analyzer 130. For example, the user semantic information generator 140 may collect computer information “Blue laptop” and computer location information “White desk” corresponding to the text information “computer” through analysis of the personalized semantic information. The user semantic information generator 140 may generate the personalized user input information that specifies the user input based on various collected or generated information. The personalized user input information is text data and may include a phrase or sentence that is a set of a plurality of words. For example, the user semantic information generator 140 may generate the personalized user input information including the phrase “Blue laptop on the white desk in the office”, which is a set of words based on the text information “My computer”, the context information “Office”, the computer information “laptop”, and the computer location information “desk”.

In detail, the user semantic information generator 140 may convert a relatively simple input into a relatively specific set of words by generating the phrase “Blue laptop on the white desk in the office” corresponding to the speech information “My computer” input by the user.

When a user inputs “My computer” through speech, and when image segmentation is performed without the personalized user input information, the result may be that all objects corresponding to the computer present in the image data are detected. When a plurality of computers exist in the image data, there is a limitation in that the object intended by the user may not be accurately detected.

In addition, when image segmentation is performed without the personalized user input information, there is a limitation that the input information becomes complicated since the user should provide relatively specific information to detect the intended object.

Meanwhile, when using the personalized image segmentation device according to an embodiment of the present disclosure, even if the user inputs relatively simple information, an object that matches the user's intention may be detected in the image data using the user's personalized semantic data.

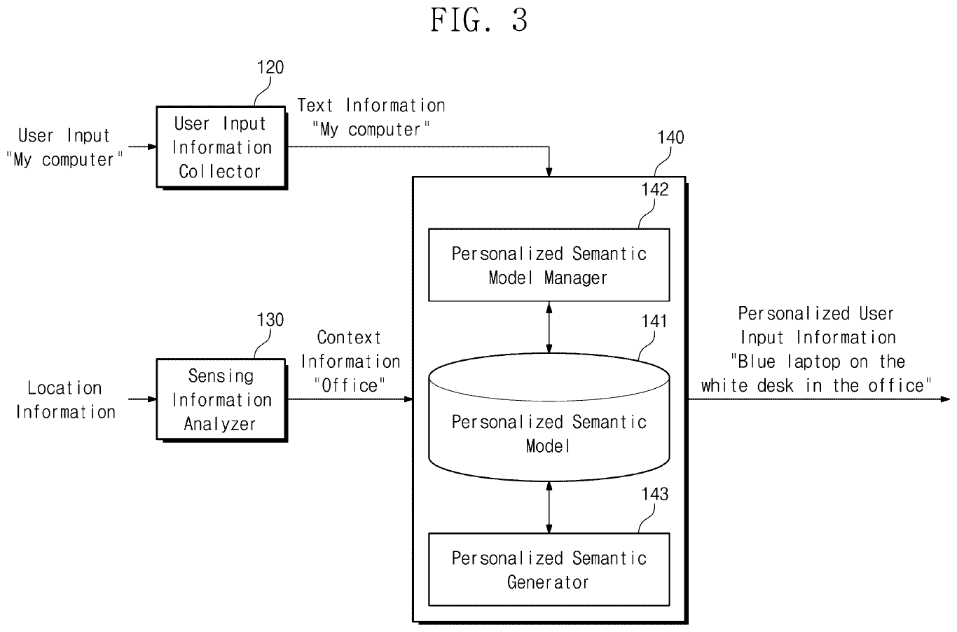

FIG. 3 is a block diagram for describing a user semantic information generator of FIG. 1.

Referring to FIG. 3, the user semantic information generator 140 may include a personalized semantic model 141, a personalized semantic model manager 142, and a personalized semantic generator 143.

The personalized semantic model 141 may store personalized semantic information. In detail, the personalized semantic model 141 is a model that systematically organizes information related to a user. The personalized semantic model 141 may store personalized semantic information corresponding to various types of information related to the user, such as feature information about objects owned by the user, information about spaces that the user frequently visits, or information about the user's tastes. The personalized semantic model 141 may include a storage device for storing personalized semantic information.

The personalized semantic model manager 142 may update the personalized semantic model 141. In detail, the personalized semantic model manager 142 may generate various types of information related to the user. The personalized semantic model manager 142 may update the personalized semantic model 141 based on various generated information.

The personalized semantic generator 143 may generate personalized user input information based on personalized semantic information, input information, and context information. The personalized semantic generator 143 may analyze personalized semantic information stored in the personalized semantic model 141, input information received from the user input information collector 120, and context information received from the sensing information analyzer 130. The personalized semantic generator 143 may generate personalized user input information based on analysis.

The user input information collector 120 may receive speech information “My computer” in a first format and may convert it into input information “My computer” in a second format. The user input information collector 120 may output the input information “My computer.” The sensing information analyzer 130 may receive location information from a GPS signal receiver and may analyze the location information to generate context information “Office”. The sensing information analyzer 130 may output the context information “Office”. The user semantic information generator 140 may receive input information “My computer” and context information “Office” in response to speech information “My computer” corresponding to the user input. The personalized semantic generator 143 may analyze the input information “My computer” and the context information “Office” based on the personalized semantic information stored in the personalized semantic model 141. The personalized semantic generator 143 may configure the computer information “Blue laptop” and the computer's location information “White desk” based on the input information “My computer”, the context information “Office”, and the personalized semantic information stored in the personalized semantic model 141. The personalized semantic generator 143 may generate a phrase “blue laptop on a white desk in the office” that materializes the user's speech input “My computer”.

That is, the user semantic information generator 140 may output the personalized user input information based on the input information received from the user input information collector 120 and the context information received from sensing information analyzer 130 through the personalized semantic model 141, the personalized semantic model manager 142, and the personalized semantic generator 143.

Meanwhile, the personalized semantic model manager 142 may update the personalized semantic model 141 based on the user's feedback. For example, the personalized semantic model manager 142 may determine the similarity between current input information and previous input information. The personalized semantic model manager 142 may update the personalized semantic information based on the current input information when the similarity between the current input information and the previous input information is greater than a preset threshold.

The personalized semantic model manager 142 may generate personalized semantic information based on the current input information when the similarity is equal to or less than a preset threshold. The personalized semantic model manager 142 may store the newly generated personalized semantic information in the personalized semantic model 141.

When the personalized semantic model manager 142 determines the similarity between the current input information and the previous input information, the similarity will be determined based on word similarity and contextual similarity between the current input information and the previous input information.

The word similarity indicates the similarity between words included in a phrase or sentence of current input information and individual words included in a phrase or sentence of previous input information. As an example, word embeddings, a technology that maps words to high-dimensional vectors, may be used to calculate word similarity. As another example, word similarity between the current input information and the previous input information may be calculated using a similarity metric such as cosine similarity or Jaccard similarity.

The contextual similarity evaluates the similarity between two or more texts by considering the context in which the word is used. When comparing current input information with previous input information, a vector space model is used to combine word vectors to generate phrase or sentence vectors, through which contextual similarity may be quantified.

The personalized semantic model manager 142 may use a pre-trained machine learning model or deep learning model to determine the similarity between current input information and previous input information.

When the similarity between the current input information and the previous input information is greater than a preset threshold, the current input information may be determined to be the user's feedback specifying the previous input information. Therefore, the personalized semantic information stored in the personalized semantic model 141 may be updated based on the current input information. When the similarity between the current input information and the previous input information is equal to or less than a preset threshold, the current input information may be determined to be a new user input. Therefore, newly generated personalized semantic information based on the current input information may be stored in the personalized semantic model 141.

The personalized semantic model manager 142 compares the current input information with the previous input information to determine the similarity between the current input information and the previous input information, thereby reflecting the user's feedback transferred as the input information in the personalized semantic model 141.

Meanwhile, the personalized semantic model manager 142 may perform user profiling at preset periods. The personalized semantic model manager 142 may update personalized semantic information based on user profiling.

The user profiling is an operation that utilizes user data to analyze user behavior features and process and classify information in various ways to predict behavior. The personalized semantic model manager 142 may periodically perform a profiling operation to generate personalized semantic information corresponding to information about the user, and may store the generated personalized semantic information in the personalized semantic model 141.

For example, the personalized semantic model manager 142 performs user profiling to store input information “My computer” corresponding to the user input and computer information “Blue laptop”, which is personalized semantic information corresponding to the context information “Office”, in the personalized semantic model 141. The personalized semantic model manager 142 may perform user profiling to store the computer's location information “White desk”, which is personalized semantic information, in the personalized semantic model 141. As described above, when materializing user input, the personalized semantic generator 143 may use the computer information “Blue laptop” and the computer location information “White desk” stored in the personalized semantic model 141 through the user profiling.

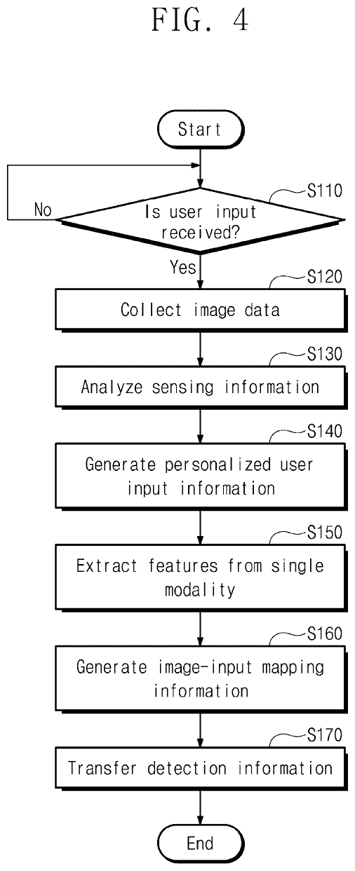

FIG. 4 is a flowchart illustrating a personalized image segmentation method, according to an embodiment of the present disclosure.

Referring to FIG. 4, the personalized image segmentation method according to an embodiment of the present disclosure may determine whether a user input in the first format is received (S110). Operation S110 may be performed by the user input information collector 120. When it is determined that the user input in the first format is not received (S110—No), the personalized image segmentation method may wait to receive the user input. The received user input in the first format may be converted to the second format, and input information in the second format may be generated as a result of the conversion.

As an example, the first format may include a speech format, and the second format may include a text format. In this case, the speech input in the speech format may be converted to input information in the text format. As another example, the second format may include an image format. In this case, handwriting input in the image format may be converted to input information in the text format.

When it is determined that a user input in the first format is received (S110—Yes), the personalized image segmentation method may collect image data in response to the user input (S120). Operation S120 may be performed by the multimodal foundation model 110.

The personalized image segmentation method may collect sensing information in response to the user input and may analyze the collected sensing information (S130). Operation S130 may be performed by the sensing information analyzer 130. Context information may be generated based on analysis of sensing information. The contextual information may indicate the user's current behavior, location, or status.

Meanwhile, the sensing information may include at least one of location information and inertial information.

The personalized image segmentation method may generate personalized user input information based on personalized semantic information, input information, and contextual information (S140). Operation S140 may be performed by the user semantic information generator 140.

The personalized image segmentation method may extract features from a single modality by encoding the collected image data and personalized input information (S150). Through this, the personalized image segmentation method may generate feature information corresponding to the image data.

The personalized image segmentation method may generate image-input mapping information (S160). The personalized image segmentation method may fuse extracted features and may segment the image data corresponding to user input. In detail, an object corresponding to the user input may be detected from image data based on feature information and personalized user input information.

The personalized image segmentation method may transfer detection information (S170). The detection information may include information such as distance, location, and shape about the segmented object. The personalized image segmentation method may convert information such as distance, location, and shape of objects segmented from image data into various sensory information such as hearing, tactile, and visual, and may transfer the detection information converted into the sensory information to a display device outside the personalized image segmentation device. The display device may display objects segmented from image data in various ways based on received sensory information. For example, segmented objects may be displayed on image data through hearing, tactile, or visual methods.

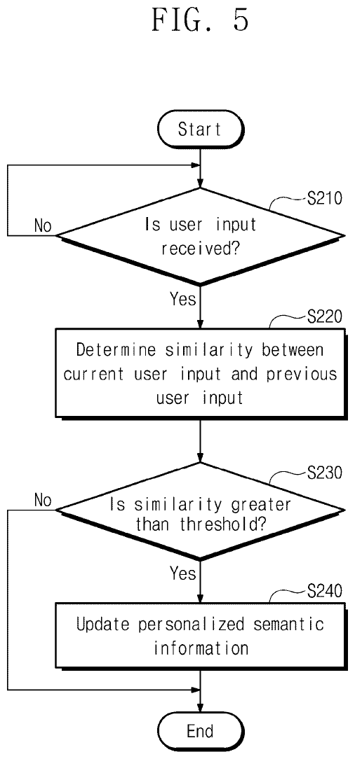

FIG. 5 is a flowchart for describing an update of a personalized semantic model of FIG. 3.

Referring to FIG. 5, to update the personalized semantic model 141, the personalized image segmentation method may determine whether user input is received (S210). When it is determined that the user input is not received (S210—No), the personalized image segmentation method may wait to receive the user input. Operation S210 may correspond to operation S110 of FIG. 4.

When it is determined that the user input is received (S210—Yes), the personalized image segmentation method may determine the similarity between the current user input and the previous user input (S220). In this case, the similarity between the current input information and the previous input information may be determined by comparing the current input information corresponding to the current user input with the previous input information corresponding to the previous user input. Operation S220 may be performed by the personalized semantic model manager 142.

In this case, the similarity between the current input information and the previous input information may be determined based on word similarity and contextual similarity.

The personalized image segmentation method may determine whether the similarity is greater than a preset threshold (S230). Operation S230 may be performed by the personalized semantic model manager 142.

When the similarity is greater than the preset threshold (S230—Yes), the personalized image segmentation method may update the personalized semantic information based on the current input information (S240). In detail, the personalized image segmentation method may update the personalized semantic information stored in the personalized semantic model based on the similarity between the current input information and the previous input information. Operation S240 may be performed by the personalized semantic model manager 142.

When the similarity is equal to or less than the preset threshold (S230—No), the personalized image segmentation method may not update the personalized semantic information. Meanwhile, the personalized image segmentation method may generate personalized semantic information based on current input information, and the newly generated personalized semantic information may be stored in the personalized semantic model 141.

Meanwhile, the personalized image segmentation method may perform user profiling at preset periods. The personalized image segmentation method may update personalized semantic information based on user profiling.

As described above, the personalized image segmentation device according to the embodiments of the present disclosure may convert the user input into personalized user input information based on context information and personalized semantic information, thereby materializing a relatively simple user input into personalized user input information. The personalized image segmentation device may detect objects in image data using personalized user input information, thereby increasing the performance of detecting objects in image segmentation with only relatively simple input.

According to an embodiment of the present disclosure, the personalized image segmentation device according to embodiments of the present disclosure converts user input into personalized user input information based on context information and personalized semantic information, thereby materializing relatively simple user input into personalized user input information. According to an embodiment of the present disclosure, the personalized image segmentation device may detect objects in image data using personalized user input information, thereby increasing object detection performance when segmenting images with only relatively simple input.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments, but should be determined by the claims described below as well as equivalents with the claims of the present disclosure.

What is claimed is:

1. A personalized image segmentation device comprising:
a user input collector configured to output input information in a second format based on a user input in a first format received from a first external device;
a sensing information analyzer configured to output context information based on sensing information received from a second external device;
a user semantic information generator configured to analyze personalized semantic information based on the input information and the context information, and to output personalized user input information based on the personalized semantic information;
a multimodal foundation model configured to encode image data and text information respectively to generate feature information corresponding to the image data; and
an image-input decoder configured to detect an object corresponding to the user input on the image data based on the feature information and the personalized user input information.

2. The personalized image segmentation device of claim 1, wherein the user semantic information generator includes:
a personalized semantic model configured to store the personalized semantic information;
a personalized semantic model manager configured to update the personalized semantic model; and
a personalized semantic generator configured to generate the personalized user input information based on the personalized semantic information, the input information, and the context information.

3. The personalized image segmentation device of claim 2, wherein the personalized semantic model manager determines a similarity between the input information and previous input information, and
when the similarity is greater than a preset threshold, updates the personalized semantic information based on the input information.

4. The personalized image segmentation device of claim 3, wherein the personalized semantic model manager, when the similarity is equal to or less than the threshold, generates the personalized semantic information based on the input information.

5. The personalized image segmentation device of claim 3, wherein the similarity is determined based on word similarity and contextual similarity between the input information and the previous input information.

6. The personalized image segmentation device of claim 2, wherein the personalized semantic model manager performs user profiling at preset periods and updates the personalized semantic information based on the user profiling.

7. The personalized image segmentation device of claim 1, wherein the sensing information includes at least one of location information and inertial information.

8. The personalized image segmentation device of claim 1, wherein the user input collector includes a speech-to-text converter, and
the first format includes a speech format and the second format includes a text format.

9. The personalized image segmentation device of claim 1, wherein the user input collector includes a handwriting-to-text converter, and
the first format includes an image format and the second format includes a text format.

10. A personalized image segmentation method comprising:
determining whether a user input in a first format is received;
generating input information in a second format based on the user input;
collecting image data in response to the user input;
generating context information based on analysis of collected sensing information, in response to the user input;
generating personalized user input information based on personalized semantic information, the input information, and the context information;
generating feature information corresponding to the image data; and
detecting an object corresponding to the user input on the image data based on the feature information and the personalized user input information.

11. The personalized image segmentation method of claim 10, further comprising:
determining a similarity between the input information and previous input information; and
when the similarity between the input information and the previous input information is greater than a threshold, updating the personalized semantic information based on the input information.

12. The personalized image segmentation method of claim 11, further comprising:
when the similarity between the input information and the previous input information is equal to or less than the threshold, generating the personalized semantic information based on the input information; and
storing the personalized semantic information which is generated.

13. The personalized image segmentation method of claim 11, wherein the similarity is determined based on word similarity and contextual similarity between the input information and the previous input information.

14. The personalized image segmentation method of claim 10, further comprising:
performing user profiling at preset periods; and
updating the personalized semantic information based on the user profiling.

15. The personalized image segmentation method of claim 10, wherein the sensing information includes at least one of location information and inertial information.

16. The personalized image segmentation method of claim 10, wherein the first format includes a speech format, the second format includes a text format, and
the user input is a speech input.

17. The personalized image segmentation method of claim 10, wherein the first format includes an image format, the second format includes a text format, and
the user input is a handwriting input.
